(19) United States
(12) Patent Application Publication
(10) Pub. No.: US 2026/0074428 A1
(43) Pub. Date: Mar. 12, 2026

(54) Electronic Device with Monolithic Antenna Integration

(71) Applicant: Apple Inc., Cupertino, CA (US)

(72) Inventors: Christian Waldschmidt, Ulm (DE); Martin Hitzler, Ulm (DE); Mario Mueh, Ulm (DE); Zdravko Boos, Munich (DE)

(21) Appl. No.: 19/299,601

(22) Filed: Aug. 14, 2025

Related U.S. Application Data
(60) Provisional application No. 63/693,072, filed on Sep. 10, 2024.

(51) Int. Cl. H01Q 9/04; H01Q 21/00; H04B 10/40

(52) U.S. Cl. CPC H01Q 9/0485; H01Q 21/0093; H04B 10/40

(57) ABSTRACT

An electronic device may include a phased antenna array integrated into a monolithic module. The module may include a silicon bulk and a substrate grown onto the silicon bulk. Radiators of the array may be disposed on a surface of the substrate. First and second optical paths may be embedded in photonic layers of the substrate. The array may include photodiodes embedded in the substrate and electrically coupled to the radiators. The first and second optical paths may illuminate the photodiodes using first and second optical signals. An electro-optical modulator (EOM) may be shared by the radiators and may modulate data onto the first optical signal. Optical phase shifters for each radiator may be disposed on the first optical path. The EOM may be non-overlapping with respect to the array.

This application claims the benefit of U.S. Provisional Patent Application No. 63/693,072, filed September 10, 2024, which is hereby incorporated by reference herein in its entirety.

### FIELD

This disclosure relates generally to electronic devices, including electronic devices with wireless communications circuitry.

### BACKGROUND

Electronic devices are often provided with wireless circuitry such as antennas. The antennas can convey signals at relatively high frequencies to maximize the data rate of the wireless circuitry.

In practice, it can be challenging to provide antennas with satisfactory levels of wireless performance, particularly as the frequencies handled by the antennas increase. For example, it can be difficult to provide the antennas with sufficient efficiency and/or bandwidth and with signal routing that does not introduce excessive loss.

### SUMMARY

An electronic device may include wireless circuitry for performing wireless communications. The wireless circuitry may include a phased antenna array. The phased antenna array may include antennas having radiators. The phased antenna array may be integrated into a monolithic antenna module.

The monolithic antenna module may include a silicon bulk and a backend-of-line (BEOL) substrate grown onto the silicon bulk. The radiators may be disposed on a surface of the substrate opposite the silicon bulk. The substrate may include one or more photonic layers and a stack of electrical layers. First and second optical paths may be embedded in the photonic layers. The first optical path may convey a first optical signal at a first wavelength. The second optical path may convey a second optical signal at a second wavelength.

The phased antenna array may include photodiodes embedded in the one or more photonic layers or in the stack of electrical layers. The photodiodes may be electrically coupled to the radiators. The first and second optical paths may illuminate the photodiodes using the first and second optical signals. An electro-optical modulator (EOM) may be disposed on the first optical path and may modulate wireless data onto the first optical signal (e.g., the EOM may be shared by each of the radiators in the array). Optical phase shifters may also be disposed on the first optical path and may impart optical phase shifts to the first optical signal. Optical couplers may couple the first and second optical paths to the photodiodes. The photodiodes may overlap the radiators. The EOM may be non-overlapping with respect to the phased antenna array. The optical couplers and the optical phase shifters may overlap the radiators or may be non-overlapping with respect to the radiators.

An aspect of the disclosure provides an integrated circuit. The integrated circuit can include a silicon bulk. The integrated circuit can include a dielectric substrate on the silicon bulk. The integrated circuit can include a photodiode. The integrated circuit can include a first optical path embedded in the dielectric substrate and configured to illuminate the photodiode using a first optical signal. The integrated circuit can include a second optical path embedded in the dielectric substrate and configured to illuminate the photodiode using a second optical signal. The integrated circuit can include an antenna having a radiator on a surface of the dielectric substrate opposite the silicon bulk, the photodiode having an electrical terminal communicatively coupled to the radiator.

An aspect of the disclosure provides an antenna module. The antenna module can include a silicon bulk. The antenna module can include a dielectric substrate layered onto the silicon bulk. The antenna module can include a phased antenna array. The phased antenna array can include radiators formed from conductive traces on a surface of the dielectric substrate opposite the silicon bulk. The phased antenna array can include photodiodes electrically coupled to the radiators. The antenna module can include a first optical path embedded in the dielectric substrate and configured to convey a first optical signal that illuminates the photodiodes in the phased antenna array. The antenna module can include a second optical path embedded in the dielectric substrate and configured to convey a second optical signal that illuminates the photodiodes in the phased antenna array.

An aspect of the disclosure provides an electronic device. The electronic device can include a silicon bulk. The electronic device can include a dielectric substrate grown onto the silicon bulk. The electronic device can include a first antenna radiator on a surface of the dielectric substrate opposite the silicon bulk. The electronic device can include a second antenna radiator on the surface of the dielectric substrate. The electronic device can include a first photodiode communicatively coupled to the first antenna radiator. The electronic device can include a second photodiode communicatively coupled to the second antenna radiator. The electronic device can include first and second optical combiners embedded in the dielectric substrate. The electronic device can include first and second optical phase shifters embedded in the dielectric substrate. The electronic device can include a first optical path that couples the first optical combiner to the first photodiode. The electronic device can include a second optical path that couples the second optical combiner to the second photodiode. The electronic device can include a first waveguide embedded in the dielectric substrate, coupled to the first and second optical combiners, and configured to convey a first optical local oscillator (LO) signal to the first and second optical combiners. The electronic device can include a second waveguide embedded in the dielectric substrate, coupled to the first and second optical combiners, and configured to convey a second optical LO signal to the first and second optical combiners. The electronic device can include an electro-optical modulator embedded in the dielectric substrate, disposed on the first waveguide, and configured to modulate wireless data onto the first optical LO signal.

### BRIEF DESCRIPTION OF THE DRAWINGS

FIG. 1 is a schematic diagram of an illustrative electronic device having wireless circuitry in accordance with some embodiments.

FIG. 2 is a diagram of an illustrative phased antenna array that may be adjusted to form beams of signals oriented in different directions in accordance with some embodiments.

FIG. 3 is a schematic diagram of illustrative wireless circuitry in an electronic device in accordance with some embodiments.

FIG. 4 is a diagram of an illustrative dipole antenna in accordance with some embodiments.

FIG. 5 is a diagram showing how an illustrative dipole antenna may be fed using optical signals in accordance with some embodiments.

FIG. 6 is a diagram of an illustrative antenna having multiple dipole antenna resonating elements for covering different polarizations in accordance with some embodiments.

FIG. 7 is a cross-sectional side view of an illustrative antenna integrated into a monolithic antenna module in accordance with some embodiments.

FIG. 8 is a perspective view of three illustrative antennas in a monolithic antenna module in accordance with some embodiments.

FIG. 9 is a top view of an illustrative photonic portion of a monolithic antenna module having optical phase shifters overlapping corresponding antenna radiators in accordance with some embodiments.

FIG. 10 is a top view of an illustrative photonic portion of a monolithic antenna module having optical phase shifters that are offset from corresponding antenna radiators in accordance with some embodiments.

### DETAILED DESCRIPTION

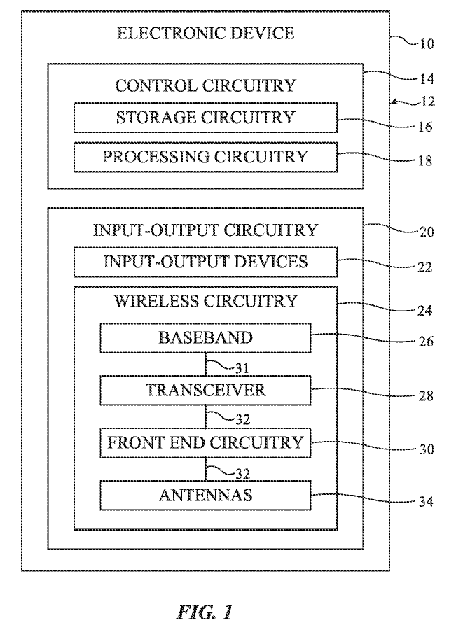

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head (e.g., a head-mounted device or head-mounted display such as a virtual, augmented, or mixed reality device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols – sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24 or radio-frequency circuitry 24) may include baseband circuitry such as baseband circuitry 26 (e.g., one or more baseband processors and/or other circuitry that operates at baseband), radio-frequency (RF) transceiver circuitry such as transceiver 28, radio-frequency front end circuitry such as front end circuitry 30, and one or more antennas 34. If desired, wireless circuitry 24 may include multiple antennas 34 that are arranged into a phased antenna array (sometimes referred to as a phased array antenna) that conveys radio-frequency signals within a corresponding signal beam that can be steered in different directions. Baseband circuitry 26 may be coupled to transceiver 28 over one or more baseband signal paths 31. Baseband circuitry 26 may include, for example, modulators (encoders) and demodulators (decoders) that operate on baseband signals. Transceiver 28 may be coupled to antennas 34 over one or more transmission line paths 32. Front end circuitry 30 may be disposed on transmission line path(s) 32 between transceiver 28 and antennas 34.

In the example of FIG. 1, wireless circuitry 24 is illustrated as including only a single transceiver 28 and a single transmission line path 32 for the sake of clarity. In general, wireless circuitry 24 may include any desired number of transceivers 28, any desired number of transmission line paths 32, and any desired number of antennas 34. Each transceiver 28 may be coupled to one or more antennas 34 over respective transmission line paths 32. Each transmission line path 32 may have respective front end circuitry 30 disposed thereon. If desired, front end circuitry 30 may be shared by multiple transmission line paths 32.

Transmission line path(s) 32 may be coupled to antenna feeds on one or more antennas 34. Each antenna feed may, for example, include a positive antenna feed terminal and a ground antenna feed terminal. Each transmission line path 32 may include a positive transmission line signal path (signal conductor) that is coupled to one or more positive antenna feed terminals and may have a ground transmission line signal path (ground conductor) that is coupled to the ground antenna feed terminal. This example is illustrative and, in general, antennas 34 may be fed using any desired antenna feeding scheme.

Each transmission line path 32 may include one or more radio-frequency transmission lines that are used to route radio-frequency signals within device 10. Radio-frequency transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission line path 32 may also include radio-frequency connectors that couple multiple radio-frequency transmission lines together. Radio-frequency transmission lines in transmission line path 32 may be integrated into rigid and/or flexible printed circuit boards. In some implementations, radio-frequency transmission lines may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). If desired, one or more transmission line paths 32 may include one or more optical transmission lines (e.g., optical fibers or waveguides in implementations where transceiver 28 includes electro-optical transceiver circuitry) instead of or in addition to radio-frequency transmission lines.

In performing wireless transmission, baseband circuitry 26 may provide baseband signals to transceiver 28 over baseband signal path(s) 31. Transceiver 28 may sometimes also be referred to herein as radio 28. Transceiver 28 (e.g., one or more transmitters in transceiver 28) may include circuitry for converting the baseband signals received from baseband circuitry 26 into corresponding radio-frequency signals. For example, transceiver 28 may include mixer circuitry that up-converts the baseband signals to radio frequencies prior to transmission over antennas 34. Transceiver 28 may also include digital to analog converter (DAC) and/or analog to digital converter (ADC) circuitry that converts signals between digital and analog domains. Transceiver 28 may transmit the radio-frequency signals over antennas 34 via transmission line path 32 and front end circuitry 30. Antennas 34 may transmit the radio-frequency signals to external wireless equipment by radiating the radio-frequency signals into free space.

In performing wireless reception, antennas 34 may receive radio-frequency signals from the external wireless equipment. The received radio-frequency signals may be conveyed to transceiver 28 via transmission line path 32 and front end circuitry 30. Transceiver 28 may include circuitry for converting the received radio-frequency signals into corresponding baseband signals. For example, transceiver 28 may include one or more receivers having mixer circuitry that down-converts the received radio-frequency signals to baseband frequencies prior to conveying the baseband signals to baseband circuitry 26.

Front end circuitry 30 may include radio-frequency front end components that operate on radio-frequency signals conveyed over radio-frequency transmission lines in transmission line path 32. If desired, the radio-frequency front end components may be formed within one or more radio-frequency front end modules (FEMs). Each FEM may include a common substrate such as a printed circuit board substrate for each of the radio-frequency front end components in the FEM. The radio-frequency front end components in front end circuitry 30 may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, etc.), impedance matching circuitry (e.g., circuitry that helps to match the impedance of antennas 34 to the impedance of transmission line path 32), antenna tuning circuitry (e.g., networks of capacitors, resistors, inductors, and/or switches that adjust the frequency response of antennas 34), radio-frequency amplifier circuitry (e.g., power amplifier circuitry and/or low-noise amplifier circuitry), radio-frequency coupler circuitry, charge pump circuitry, power management circuitry, digital control and interface circuitry, and/or any other desired circuitry that operates on the radio-frequency signals transmitted and/or received by antennas 34.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, baseband circuitry 26 and/or portions of transceiver 28 (e.g., a host processor on transceiver 28) may form a part of control circuitry 14.

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-10 Gbps or higher, wireless circuitry 24 may convey wireless signals at frequencies greater than about 100 GHz.

For example, transceiver 28 and wireless circuitry 24 may transmit and/or receive radio-frequency signals in one or more frequency bands greater than around 100 GHz (e.g., greater than 70 GHz, 80 GHz, 90 GHz, 110 GHz, 200 GHz, 300 GHz, etc.). Radio-frequency signals at these frequencies are sometimes also referred to as tremendously high frequency (THF) signals, sub-THz, THz signals, or sub-millimeter wave signals. The THF signals may be at sub-THz or THz frequencies such as frequencies between 100 GHz and 1 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 6G frequency band). The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna on a first chip in device 10 transmits THF signals to another antenna on a second chip in device 10), and/or to perform any other desired high data rate operations.

Antennas 34 may be formed using any desired antenna structures. For example, antennas 34 may include antennas with resonating elements that are formed from loop antenna structures, patch antenna structures, inverted-F antenna structures, slot antenna structures, planar inverted-F antenna structures, helical antenna structures, monopole antenna structures, dipole antenna structures (e.g., bowtie antenna structures), hybrids of these designs, etc. Parasitic elements may be included in antennas 34 to adjust antenna performance.

Filter circuitry, switching circuitry, impedance matching circuitry, and other circuitry may be interposed within transmission line path 32, may be incorporated into front end circuitry 30, and/or may be incorporated into antennas 34 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antennas 34 over time.

In general, transceiver 28 may cover (handle) any suitable communications (frequency) bands of interest. The transceiver may convey radio-frequency signals using antennas 34 (e.g., antennas 34 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 34 may transmit the radio-frequency signals by radiating the radio-frequency signals into free space (or to free space through intervening device structures such as a dielectric cover layer). Antennas 34 may additionally or alternatively receive the radio-frequency signals from free space (e.g., through intervening devices structures such as a dielectric cover layer). The transmission and reception of radio-frequency signals by antennas 34 each involve the excitation or resonance of antenna currents on an antenna resonating element in the antenna by the radio-frequency signals within the frequency band(s) of operation of the antennas.

In example where multiple antennas 34 are arranged in a phased antenna array, each antenna 34 may form a respective antenna element of the phased antenna array. Conveying radio-frequency signals using the phased antenna array may allow for greater peak signal gain relative to scenarios where individual antennas 34 are used to convey radio-frequency signals. In satellite navigation system links, cellular telephone links, and other long-range links, radio-frequency signals are typically used to convey data over thousands of feet or miles. In Wi-Fi® and Bluetooth® links at 2.4 and 5 GHz and other short-range wireless links, radio-frequency signals are typically used to convey data over tens or hundreds of feet. In scenarios where millimeter wave, THz, or sub-THz frequencies are used to convey radio-frequency signals, a phased antenna array may convey radio-frequency signals over short to mid-range distances that travel over a line-of-sight path. To enhance signal reception for millimeter wave, THz, or sub-THz communications, the phased antenna array may convey radio-frequency signals using beam steering techniques (e.g., schemes in which antenna signal phase and/or magnitude for each antenna in an array are adjusted to perform beam steering).

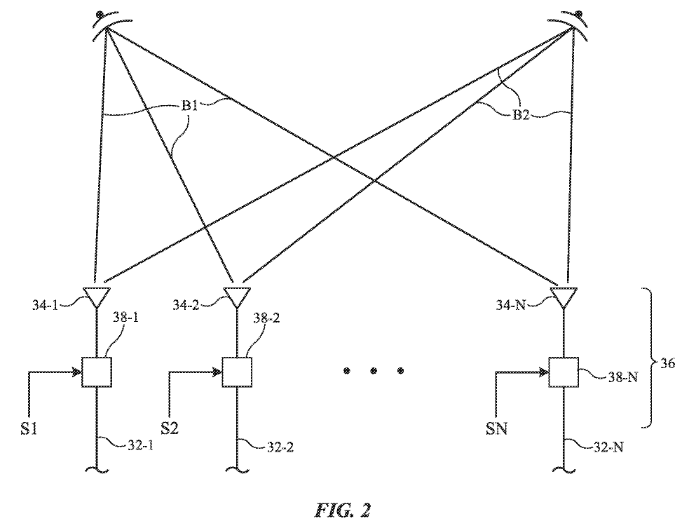

FIG. 2 shows how antennas 34 may be formed in a corresponding phased antenna array 36. As shown in FIG. 2, phased antenna array 36 (sometimes referred to herein as array 36, antenna array 36, or array 36 of antennas 34) may be coupled to transmission line paths 32. For example, a first antenna 34-1 in phased antenna array 36 may be coupled to a first transmission line path 32-1, a second antenna 34-2 in phased antenna array 36 may be coupled to a second transmission line path 32-2, an Nth antenna 34-N in phased antenna array 36 may be coupled to an Nth transmission line path 32-N, etc. While antennas 34 are described herein as forming a phased antenna array, the antennas 34 in phased antenna array 36 may sometimes also be referred to as collectively forming a single phased array antenna (e.g., where antennas 34 form antenna elements of the phased array antenna).

Antennas 34 in phased antenna array 36 may be arranged in any desired number of rows and columns or in any other desired pattern (e.g., the antennas need not be arranged in a grid pattern having rows and columns). Each antenna 34 may be separated from one or more adjacent antennas 34 in phased antenna array 36 by a predetermined distance such as approximately half an effective wavelength of operation of the array. During signal transmission operations, transmission line paths 32 may be used to supply signals (e.g., radio-frequency signals such as millimeter wave, sub-THz, or THz signals) from transceiver circuitry to phased antenna array 36 for wireless transmission. During signal reception operations, transmission line paths 32 may be used to supply signals received at phased antenna array 36 (e.g., from external wireless equipment or transmitted signals that have been reflected off of external objects) to transceiver circuitry.

The use of multiple antennas 34 in phased antenna array 36 allows beam forming/steering arrangements to be implemented by controlling the relative phases and magnitudes (amplitudes) of the radio-frequency signals conveyed by the antennas. In the example of FIG. 2, antennas 34 each have a corresponding phase and magnitude controller 38 (e.g., a first phase and magnitude controller 38-1 disposed on transmission line path 32-1 may control phase and magnitude for radio-frequency signals handled by antenna 34-1, a second phase and magnitude controller 38-2 disposed on transmission line path 32-2 may control phase and magnitude for radio-frequency signals handled by antenna 34-2, an Nth phase and magnitude controller 38-N disposed on transmission line path 32-N may control phase and magnitude for radio-frequency signals handled by antenna 34-N, etc.).

Phase and magnitude controllers 38 may each include circuitry for adjusting the phase of the radio-frequency signals on radio-frequency transmission line paths 32 (e.g., phase shifter circuits) and/or circuitry for adjusting the magnitude of the radio-frequency signals on transmission line paths 32 (e.g., power amplifier and/or low noise amplifier circuits). In situations where wireless circuitry 24 is implemented using an electro-optical architecture, phase and magnitude controllers 38 may include optical phase shifters disposed on corresponding optical signal paths. Phase and magnitude controllers 38 may sometimes be referred to collectively herein as beam steering circuitry or beam forming circuitry (e.g., beam steering/forming circuitry that steers/forms the beam of radio-frequency signals transmitted and/or received by phased antenna array 36).

Phase and magnitude controllers 38 may adjust the relative phases and/or magnitudes of the transmitted signals that are provided to each of the antennas in phased antenna array 36 and may adjust the relative phases and/or magnitudes of the received signals that are received by phased antenna array 36. Phase and magnitude controllers 38 may, if desired, include phase detection circuitry for detecting the phases of the received signals that are received by phased antenna array 36. The term “beam” or “signal beam” may be used herein to collectively refer to wireless signals that are transmitted and/or received by phased antenna array 36 in a particular direction. Each beam may exhibit a peak gain that is oriented in a respective beam pointing direction at a corresponding beam pointing angle (e.g., based on constructive and destructive interference from the combination of signals from each antenna in the phased antenna array). Different sets of phase and magnitude settings for phase and magnitude controllers 38 may configure phased antenna array 36 to form different beams in different beam pointing directions.

If, for example, phase and magnitude controllers 38 are adjusted to produce a first set of phases and/or magnitudes, the signals will form a beam as shown by beam B1 of FIG. 2 that is oriented in the direction of point A. If, however, phase and magnitude controllers 38 are adjusted to produce a second set of phases and/or magnitudes, the signals will form a beam as shown by beam B2 that is oriented in the direction of point B. Each phase and magnitude controller 38 may be controlled to produce a desired phase and/or magnitude based on a corresponding control signal S received from control circuitry 14 of FIG. 1 (e.g., the phase and/or magnitude provided by phase and magnitude controller 38-1 may be controlled using control signal S1, the phase and/or magnitude provided by phase and magnitude controller 38-2 may be controlled using control signal S2, the phase and/or magnitude provided by phase and magnitude controller 38-N may be controlled using control signal SN, etc.). If desired, the control circuitry may actively adjust control signals S in real time to steer (form) the beam in different desired directions over time. Phase and magnitude controllers 38 may provide information identifying the phase of received signals to control circuitry 14 if desired.

When performing wireless communications using radio-frequency signals at relatively high frequencies such as millimeter wave, sub-THz, or THz frequencies, radio-frequency signals are conveyed over a line-of-sight path between phased antenna array 36 and external communications equipment. If the external equipment is located at point A of FIG. 2, phase and magnitude controllers 38 may be adjusted to steer the signal beam towards point A (e.g., to steer the pointing direction of the signal beam towards point A). Phased antenna array 36 may transmit and receive radio-frequency signals in the direction of point A. Similarly, if the external equipment is located at point B, phase and magnitude controllers 38 may be adjusted to steer the signal beam towards point B (e.g., to steer the pointing direction of the signal beam towards point B). Phased antenna array 36 may transmit and receive radio-frequency signals in the direction of point B.

In the example of FIG. 2, beam steering is shown as being performed over a single degree of freedom for the sake of simplicity (e.g., towards the left and right on the page of FIG. 2). However, in practice, the beam may be steered over two or more degrees of freedom (e.g., in three dimensions, into and out of the page and to the left and right on the page of FIG. 2). Phased antenna array 36 may have a corresponding field of view over which beam steering can be performed (e.g., in a hemisphere or a segment of a hemisphere over the phased antenna array).

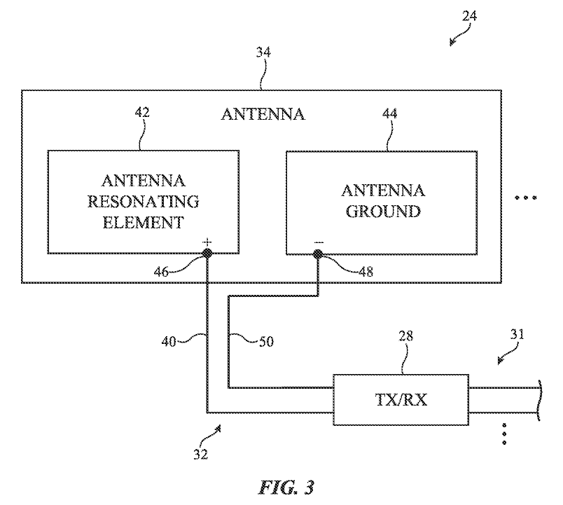

FIG. 3 is a diagram showing how transceiver circuitry 28 may be coupled to an antenna 34 (e.g., an antenna 34 in phased antenna array 36 of FIG. 2). As shown in FIG. 3, antenna 34 may include one or more antenna conductors formed from conductive material such as metal. The antenna conductors may include one or more antenna conductors that form antenna resonating element 42 (sometimes referred to as an antenna resonator, an antenna radiator, an antenna radiating element, a radiating arm, or a resonating element arm) and one or more antenna conductors that form antenna ground 44 (sometimes referred to as a ground plane).

Antenna 34 may have an antenna feed coupled between antenna resonating element 42 and antenna ground 44. The antenna feed may have a first (positive or signal) antenna feed terminal 46 coupled to antenna resonating element 42. The antenna feed may also have a second (ground or negative) antenna feed terminal 48 coupled to antenna ground 44. Antenna resonating element 42 may be separated from antenna ground 44 by a dielectric (non-conductive) gap. Antenna resonating element 42 and antenna ground 44 may be formed from separate pieces of metal or other conductive materials or may, if desired, be formed from separate portions of the same integral piece of metal. If desired, antenna 34 may include additional antenna conductors that are not coupled to antenna feed terminals 46 and 48 (e.g., parasitic elements). For some types of antennas (e.g., in implementations where antenna 34 is a slot antenna), the antenna resonating element may be formed from a slot in a single antenna conductor that is coupled to both antenna feed terminals 46 and 48 (e.g., where antenna feed terminals 46 and 48 are coupled to opposing sides of the slot).

Transmission line path 32 may couple antenna 34 to transceiver (TX/RX) 28. Transmission line 32 may include a radio-frequency transmission line having a signal conductor such as signal conductor 40 (e.g., a positive signal conductor) and having a ground conductor such as ground conductor 50. Ground conductor 50 may be coupled to ground antenna feed terminal 48 of antenna 34. Signal conductor 40 may be coupled to positive antenna feed terminal 46 of antenna 34. In some implementations, signal conductor 40 may extend all the way from positive antenna feed terminal 46 to transceiver 28 and ground conductor 50 may extend all the way from ground antenna feed terminal 48 to transceiver 28. In other implementations (e.g., electro-optical implementations), signal conductor 40 and ground conductor 50 may couple antenna feed terminals 46 and 48 to an electro-optical device such as a photodiode that is coupled to optical components in transceiver 28 over optical signal paths. The photodiode may convert optical signals received over the optical signal paths into radio-frequency signals provided to antenna feed terminals 46 and 48 over signal conductor 40 and ground conductor 50.

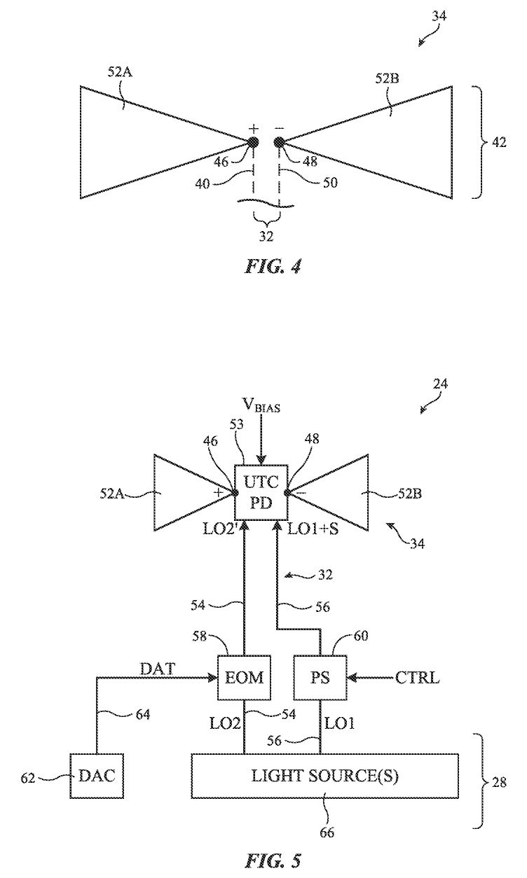

In some implementations that are described herein as an example, antenna 34 may include a dipole antenna resonating element (e.g., antenna resonating element 42 may be a dipole antenna resonating element, configuring antenna 34 to form a dipole antenna). FIG. 4 is a top view showing one example of how antenna 34 may be implemented as a dipole antenna.

As shown in FIG. 4, the antenna resonating element 42 of antenna 34 may include two or more dipole arms 52 such as a first dipole arm 52A and a second dipole arm 52B. Dipole arms 52A and 52B may be planar (e.g., may lie in a planar surface). Positive antenna feed terminal 46 may be coupled to a first end of dipole arm 52A. Ground antenna feed terminal 48 may be coupled to a first end of dipole arm 52B (facing the first end of dipole arm 52A). Signal conductor 40 of transmission line path 32 may be coupled to positive antenna feed terminal 46. Ground conductor 50 of transmission line path 32 may be coupled to ground antenna feed terminal 48. Implementing antenna 34 as a dipole antenna may eliminate the need for a separate ground plane (e.g., in antenna ground 44 of FIG. 3) under antenna resonating element 42 because dipole arm 52A is referenced to dipole arm 52B. This may serve to increase the flexibility with which antenna 34 can be integrated into device 10 without sacrificing wireless performance.

If desired, dipole arms 52A and 52B may be bowtie arms (e.g., antenna resonating element 42 may be a bowtie antenna resonating element and antenna 34 may be a bowtie antenna or a bowtie dipole antenna). When implemented as a bowtie arm (as shown in the example of FIG. 4), dipole arm 52A has a first width at the first end of dipole arm 52A (positive antenna feed terminal 46). Dipole arm 52A laterally extends from the first end to an opposing second end (opposite positive antenna feed terminal 46). Dipole arm 52A has a second width at the second end that is greater than the first width. Similarly, when implemented as a bowtie arm, dipole arm 52B has a first width at the first end of dipole arm 52B (ground antenna feed terminal 48). Dipole arm 52B laterally extends from the first end to an opposing second end (opposite ground antenna feed terminal 48). Dipole arm 52B has a second width at the second end that is greater than the first width.

In the example of FIG. 4, dipole arms 52A and 52B are triangular. This is illustrative and non-limiting. In general, dipole arms 52A and 52B may have any desired shapes (e.g., following any desired path having any desired number of straight and/or curved segments, having any desired number of curved and/or straight edges, etc.). In practice, it can be challenging to incorporate components into wireless circuitry 24 that support wireless communications at relatively high frequencies such as millimeter, sub-THz, or THz frequencies. If desired, wireless circuitry 24 may be implemented using an electro-optical architecture in which wireless circuitry 24 includes optical components that convey optical signals to support the transmission and/or reception of radio-frequency signals by antenna resonating element 42 at these frequencies in a space and resource-efficient manner.

FIG. 5 is a diagram showing one example of how wireless circuitry 24 may be implemented using an electro-optical architecture (e.g., for feeding antenna 34 using optical signals). As shown in FIG. 5, antenna 34 may include an electro-optical device such as photodiode (PD) 53.

Photodiode 53 may have a first electrical terminal coupled to positive antenna feed terminal 46 on dipole arm 52A (e.g., via signal conductor 40 of FIG. 4, which has been omitted from FIG. 5 for the sake of clarity). Photodiode 53 may have a second electrical terminal coupled to ground antenna feed terminal 46 on dipole arm 52B (e.g., via ground conductor 50 of FIG. 4, which has been omitted from FIG. 5 for the sake of clarity). The signal and ground conductors may include conductive vias and/or conductive traces on an underlying substrate, as one example.

Transceiver circuitry 28 may include optical components such as one or more light sources 66. Transmission line path 32 may include optical paths 54 and 56. Optical paths 54 and 56 may optically couple light source(s) 66 to photodiode 53. Light source(s) 66 may emit a first optical signal such as optical local oscillator (LO) signal LO1 onto optical path 56. At the same time, light source(s) 66 may emit a second optical signal such as optical local oscillator signal LO2 onto optical path 54. Photodiode 53 may be illuminated using the optical local oscillator signals propagating along optical paths 54 and 56.

Photodiode 53 may be a programmable photodiode. An example in which photodiode 53 is a programmable uni-travelling-carrier photodiode (UTC PD) is described herein as an example. Photodiode 53 may therefore sometimes be referred to herein as UTC PD 53 or programmable UTC PD 53. This is illustrative and, in general, photodiode 53 may include any desired type of adjustable/programmable photodiode or component that converts electromagnetic energy at optical frequencies to current at THF frequencies on dipole arms 52A and 52B and/or vice versa (e.g., a p-i-n diode, a tunneling diode, a TW UTC photodiode, other diodes with quadratic characteristics, an LT-GaAs photodiode, an M-UTC photodiode, a Schottky diode, other types of heterodyne devices, etc.).

UTC PD 53 may have an electrical bias terminal (input) that receives one or more control signals V_{BIAS} from control circuitry 14 (FIG. 1). Control signals V_{BIAS} may include bias voltages provided at one or more voltage levels and/or other control signals for controlling the operation of UTC PD 53 such as impedance adjustment control signals for adjusting the output impedance of UTC PD 53. Control circuitry 14 (FIG. 1) may provide (e.g., apply, supply, assert, etc.) control signals V_{BIAS} at different settings (e.g., values, magnitudes, etc.) to dynamically control (e.g., program or adjust) the operation of UTC PD 53 over time. For example, control signals V_{BIAS} may be used to control whether antenna 34 transmits radio-frequency signals or receives radio-frequency signals. When control signals V_{BIAS} include a bias voltage asserted at a first level or magnitude, antenna 34 may be configured to transmit radio-frequency signals. The bias voltage supplies transmit power for the antenna, which may be drawn from this supply. The diode modulates DC current that is driven by the bias voltage and the superimposed RF current fraction then excites the radiating element to radiate. The external optical field (e.g., from the optical local oscillator signals) forms the influence that controls the creation of free charge carriers in the diode substrate (e.g., the capability for passing current), but only supplies a diminishing fraction of the actual transmit power (if any). In practice, some but not all of the bias voltage can be converted into an RF voltage due to limited conversion efficiency. When control signals V_{BIAS} include a bias voltage asserted at a second level or magnitude, antenna 34 may be configured to receive radio-frequency signals. If desired, control signals V_{BIAS} may also be adjusted to control the waveform of the radio-frequency signals (e.g., as a squaring function that preserves the modulation of incident optical signals, a linear function, etc.), to perform gain control on the signals conveyed by antenna 34, and/or to adjust the output impedance of UTC PD 53.

Optical paths 54 and 56 may include optical fibers and/or waveguides. Optical local oscillator signals LO1 and LO2 may be at visible wavelengths (e.g., between 400 nm and 700 nm), ultra-violet wavelengths (e.g., near-ultra-violet or extreme ultraviolet wavelengths), and/or infrared wavelengths (e.g., near-infrared wavelengths, mid-infrared wavelengths, or far-infrared wavelengths). Optical local oscillator signal LO2 may be offset in wavelength from optical local oscillator signal LO1 by a wavelength offset X. Wavelength offset X may be equal to the wavelength of the radio-frequency signals conveyed by antenna 34 (e.g., between 100 GHz and 1 THz (1000 GHz), between 100 GHz and 2 THz, between 300 GHz and 800 GHz, between 300 GHz and 1 THz, between 300 and 400 GHz, etc.).

During signal transmission, wireless data (e.g., wireless data packets, symbols, frames, etc.) may be modulated onto optical local oscillator signal LO2 to produce modulated optical local oscillator signal LO2’. For example, an electro-optical modulator 58 may be disposed on optical path 54. Electro-optical modulator (EOM) 58 may receive wireless data DAT (e.g., as electrical signals) over data path 64 from digital-to-analog converter 62 (or other transmitter circuitry) in transceiver 28.

EOM 58 (sometimes referred to herein as optical modulator 58) may be, for example, a Mach-Zehnder modulator (MZM) or another type of electro-optical modulator. EOM 58 may, for example, include a first optical arm (branch) and a second optical arm (branch) coupled in parallel along optical path 54. Propagating optical local oscillator signal LO2 along the arms of EOM 58 may, in the presence of a voltage signal applied to one or both arms, allow different optical phase shifts to be imparted on each arm before recombining the signal at the output of the electro-optical modulator (e.g., where optical phase modulations produced on the arms are converted to intensity modulations at the output of EOM 58). When the voltage applied to EOM 58 includes wireless data DAT, EOM 58 may modulate the wireless data onto optical local oscillator signal LO2, producing modulated optical local oscillator signal LO2’. If desired, EOM 58 may receive one or more bias voltages (not shown) applied to one or both arms. Control circuitry 14 (FIG. 1) may provide the bias voltage with different magnitudes to place EOM 58 into different operating modes (e.g., operating modes that suppress optical carrier signals, operating modes that do not suppress optical carrier signals, etc.).

If desired, optical local oscillator signal LO1 may be provided with an optical phase shift S. For example, an optical phase shifter (PS) 60 may be disposed on optical path 56. Control circuitry 14 (FIG. 1) may provide phase control signals CTRL to optical phase shifter 60. Phase control signals CTRL may control optical phase shifter 60 to apply optical phase shift S to the optical local oscillator signal LO1 on optical path 56. Phase shift S may be selected to steer a signal beam of radio-frequency signals in a desired pointing direction (e.g., via suitable selection of phase shift S across the phased antenna array 36 (FIG. 2) that includes antenna 34). Signal beam steering is performed in the optical domain (e.g., using optical phase shifter 60) rather than in the radio-frequency domain because there are generally no satisfactory phase shifting circuit components that operate at frequencies as high sub-THz or THz frequencies. Optical phase shifter 60 may form a part of the phase and magnitude controller 38 (FIG. 2) for antenna 34.

Optical phase shifter 60 may pass the phase-shifted optical local oscillator signal LO1 (denoted as LO1 + S or LO1 + ϕ) to UTC PD 53 over optical path 56. At the same time, EOM 58 may pass the modulated optical local oscillator signal LO2’ to UTC PD 53 over optical path 54. If desired, an optical combiner (not shown) may combine optical signals on optical paths 54 and 56 prior to illuminating UTC PD 53 with the combined optical signals. Alternatively, the optical combiner may be omitted and the optical paths may separately illuminate UTC PD 53 with their respective optical signals.

In this way, optical paths 54 and 56 may illuminate UTC PD 53 with optical local oscillator signal LO1 (plus the optical phase shift S when applied) and modulated optical local oscillator signal LO2’. If desired, lenses or other optical components (not shown) may be interposed between optical paths 54/56 and UTC PD 53 to help focus the optical local oscillator signals onto UTC PD 53.

UTC PD 53 may convert optical local oscillator signal LO1 and modulated local oscillator signal LO2’ (e.g., beats between the two optical local oscillator signals) into antenna currents that run along the perimeter of dipole arms 52A and 52B (e.g., via antenna feed terminals 46 and 48 and conductors 40 and 50 of FIG. 4). The frequency of the antenna current is equal to the frequency difference between local oscillator signal LO1 and modulated local oscillator signal LO2’ (e.g., the frequency corresponding to wavelength offset X). The antenna currents may radiate (transmit) radio-frequency signals into free space. Control signal V_{BIAS} may control UTC PD 53 to convert the optical local oscillator signals into antenna currents on dipole arms 52A and 52B while preserving the modulation and thus the wireless data on modulated local oscillator signal LO2’ (e.g., by applying a squaring function to the signals). The radiated radio-frequency signals will thereby carry the modulated wireless data for reception and demodulation by external wireless communications equipment.

The example of FIG. 5 illustrates signal transmission for the sake of clarity. Antenna 34 may also receive radio-frequency signals that are provided to transceiver circuitry 28. For example, control circuitry 14 (FIG. 1) may adjust bias voltage V_{BIAS} to place UTC PD 53 and thus antenna 34 into a reception state. Radio-frequency signals may be incident upon dipole arms 52A and 52B. The incident radio-frequency signals may produce antenna currents that flow around the perimeter of dipole arms 52A and 52B. Antenna feed terminals 46 and 48 pass the antenna currents to UTC PD 53. UTC PD 53 may use optical local oscillator signal LO1 (plus the optical phase shift S when applied), optical local oscillator signal LO2 (e.g., without modulation), and control signals V_{BIAS} (e.g., a bias voltage asserted at a second level) to convert the received radio-frequency signals into intermediate frequency signals that are output onto an intermediate frequency signal path (not shown).

The frequency of intermediate frequency signals may be equal to the frequency of the radio-frequency signals minus the difference between the frequency of optical local oscillator signal LO1 and the frequency of optical local oscillator signal LO2. As an example, the intermediate frequency signals may be at lower frequencies than the radio-frequency signals received by antenna 34 such as centimeter or millimeter wave frequencies between 10 GHz and 100 GHz, between 30 GHz and 80 GHz, around 60 GHz, etc. If desired, transceiver circuitry 28 (FIG. 1) may change the frequency of optical local oscillator signal LO1 and/or optical local oscillator signal LO2 when switching from transmission to reception or vice versa. UTC PD 53 may preserve the data modulation of THF signals 34 in the intermediate signals. A receiver in transceiver circuitry 28 (not shown) may demodulate the intermediate frequency signals (e.g., after further downconversion) to recover the wireless data from the received radio-frequency signals. In another example, wireless circuitry 24 may convert the intermediate frequency signals to the optical domain before recovering the wireless data (e.g., by providing the intermediate frequency signals to an electro-optical modulator). In yet another example, the intermediate frequency signal path may be omitted and UTC PD 53 may convert received radio-frequency signals directly into the optical domain for subsequent demodulation and data recovery (e.g., in a sideband of the optical signal).

The example of FIG. 5 in which EOM 58 is disposed on optical path 54 and optical phase shifter 60 is disposed on optical path 56 is illustrative and non-limiting. If desired, optical phase shifter 60 may be disposed on optical path 54 (e.g., between EOM 58 and UTC PD 53) or may be integrated into EOM 58 (e.g., EOM 58 may apply phase shift S to optical local oscillator signal LO2 in addition to modulating optical data onto optical local oscillator signal LO2). In these implementations, optical path 54 may deliver a phase shifted modulated local optical signal (denoted herein as LO2’ + S) to UTC PD 53. Optical path 56 may be free of optical phase shifters and may illuminate UTC PD 53 using optical local oscillator signal LO1 (e.g., without phase shift S). Alternatively, phase shifts may be applied to both optical local oscillator signals.

To perform beamforming using a phased antenna array 36 (FIG. 3) of N antennas 34 (FIG. 5), the individual RF phase of each antenna may need to be controllable within a range of +/- 180 degrees in relation to an arbitrary reference phase. This is achieved in the optical domain using optical phase shifter 60 by changing the phase of only one of the two optical local oscillator signals by +/- 180 degrees, which causes a corresponding phase shift in the electrical (RF) signal produced by UTC PD 53 after photomixing. Performing optical phase shifts in this way is relatively robust against slow phase drift of one of the two light sources 66 used to generate optical local oscillator signals LO1 and LO2, since any phase change is distributed to all of the antennas in phased antenna array 36 as a constant additive offset.

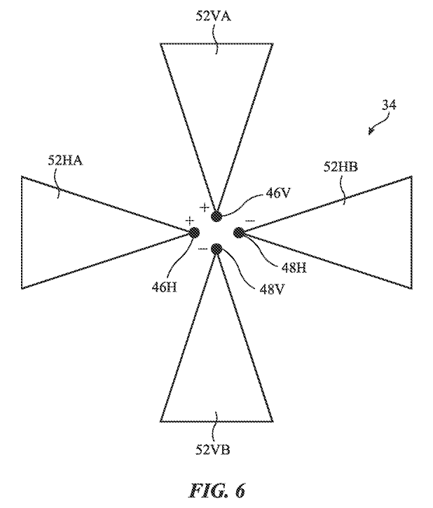

The antenna 34 of FIGS. 4 and 5 may support transmission and reception of radio-frequency signals with a given polarization (e.g., a linear polarization such as a horizontal polarization). If desired, antenna 34 may include additional dipole arms 52 for covering an additional polarization. FIG. 6 is a diagram showing one example of how antenna 34 may include multiple pairs of dipole arms 52 for covering multiple polarizations.

As shown in FIG. 6, antenna 34 may include a first pair of dipole arms 52HA and 52HB coupled to respective antenna feed terminals 46H and 48H. Antenna feed terminal 46H may be coupled to a first signal conductor 40 (FIG. 4), antenna feed terminal 48H may be coupled to a first ground conductor 50 (FIG. 4) and, if desired, antenna feed terminals 46H and 48H may be coupled to a first UTC PD 53 (not shown). Dipole arms 52HA and 52HB may be oriented in a first direction. Dipole arms 52HA and 52HB may convey radio-frequency signals with a first linear polarization such as a horizontal polarization.

Antenna 34 may also include a second pair of dipole arms 52VA and 52VB coupled to respective antenna feed terminals 46V and 48V. Antenna feed terminal 46V may be coupled to a second signal conductor 40 (FIG. 4), antenna feed terminal 48V may be coupled to a second ground conductor 50 (FIG. 4) and, if desired, antenna feed terminals 46V and 48V may be coupled to a second UTC PD 53 (not shown). Dipole arms 52VA and 52VB may be oriented in a second direction orthogonal to the first direction (e.g., dipole arms 52VA and 52VB may be perpendicular to dipole arms 52HA and 52HB). Dipole arms 52VA and 52VB may convey radio-frequency signals with a second linear polarization such as a vertical polarization.

Dipole arms 52VA, 52VB, 52HA, and 52HB may all be disposed in the same plane or, if desired, dipole arms 52VA and 52VB may be disposed in a different plane than dipole arms 52HA and 52HB. Overlapping dipole arms 52VA and 52VB with dipole arms 52HA and 52HB in this way may help to minimize space consumption within device 10.

In some implementations, the antennas in a phased antenna array are implemented as off-chip antennas or non-cooperatively controlled antennas on a surface of an integrated circuit (IC). The latter concept enables non-directional emission directly from the chip surface, while antenna bandwidth and efficiency are strongly constrained by the structure of the chip (e.g., the layer stack up, dictated by technology type) when abstaining from the use of additional external components. In other implementations, the antennas are employed as fully on-chip elements having coupled elements on the top layer of the IC. On-chip antennas such as these are highly resonant due to close proximity to internal ground metallizations of the IC and operate with relatively poor bandwidth and efficiency. In other implementations, each antenna in the phased antenna array has patch elements distributed across multiple stacked substrates coupled together using interconnects such as solder balls (e.g., in an IC package). However, distributing the antenna across multiple stacked substrates coupled together using interconnects can introduce excessive signal loss as the signals propagate through the interconnects, particularly at relatively high frequencies.

To mitigate these issues and to help minimize the volume in device 10 occupied by phased antenna array 36 (FIG. 2), to help minimize routing complexity for each of the antennas 34 in phased antenna array 36, to help minimize signal routing loss for antennas 34, and to help simplify the manufacturing/fabrication process for phased antenna array 36 (thereby minimizing device cost), each of the antennas 34 in phased antenna array 36 may be disposed within a monolithic antenna module. The monolithic antenna module may also include each of the radio-frequency and/or optical components to support the antennas (e.g., front end circuitry, phase shifters, amplifiers, signal generators, some or all of transceiver 28, optical paths, electro-optical modulators, etc.) integrated therein, preventing the need to couple an external printed circuit board or chip to the monolithic antenna module to support the antennas, which may minimize signal loss.

In other words, the monolithic antenna module may reduce or eliminate inter-chip interconnects from an IC package to the antenna array. Although fabrication of antennas as printed circuit board devices or by means off-chip increases flexibility in design, such solutions are still not as space efficient or power efficient as the monolithic antenna module (e.g., where the antennas are integrated directly into the chip), particularly at frequencies above 100 GHz. In addition, the application of interconnects requires very precise realization of the entire connection chain in every single device to achieve the full operating performance of the system, which is a complicated task at extremely high frequencies due to the resulting small dimensions and tolerance requirements. Chip technology, on the contrary, is already one of the most precise fabrication technologies available. Fabricating the antenna array on-chip does not require further precision beyond that of the IC and relaxes the constraints placed on down-stream integration into any type of device.

The integration of antennas and antenna arrays into chips is also subject to limitations created by strict height constraints of the resulting RF circuit. Antennas are three-dimensional components, which achieve efficiency and bandwidth partly by means of open space surrounding the antennas. If care is not taken, confining the antenna to a very flat plane with metallic ground planes in direct proximity can degrade performance. In addition, it can be difficult to implement the optical phase shifters 60 for the antennas 24 in the monolithic antenna module. Some types of optical phase shifters such as optical phase shifters based on specialized crystal materials or semiconductors are implemented using fiber-attached discrete components, which can be excessively bulky.

Further, technologies for integrating optical components into a semiconductor chip such as a monolithic antenna module are often unsuited for reproduction of radio-frequency (RF) components due to the applied materials. Additional devices such as an interposer can help to accommodate RF distribution and antenna instruction, but these devices require a different fabrication process than that used to manufacture the monolithic antenna module, can be excessively bulky, and/or can introduce additionally lossy interfaces to the system. To mitigate these issues, the monolithic antenna module may be fabricated as a chip-integrated signal transmission system capable of beam steering. Signal distribution is handled in the monolithic antenna module optically instead of electrically, with the signal being converted to an electrical signal only in the last stage at the antenna inputs (e.g., at UTC PDs 53). This may help to minimize cross-talk between antennas, which is particularly high in implementations where signals are distributed in the electrical domain.

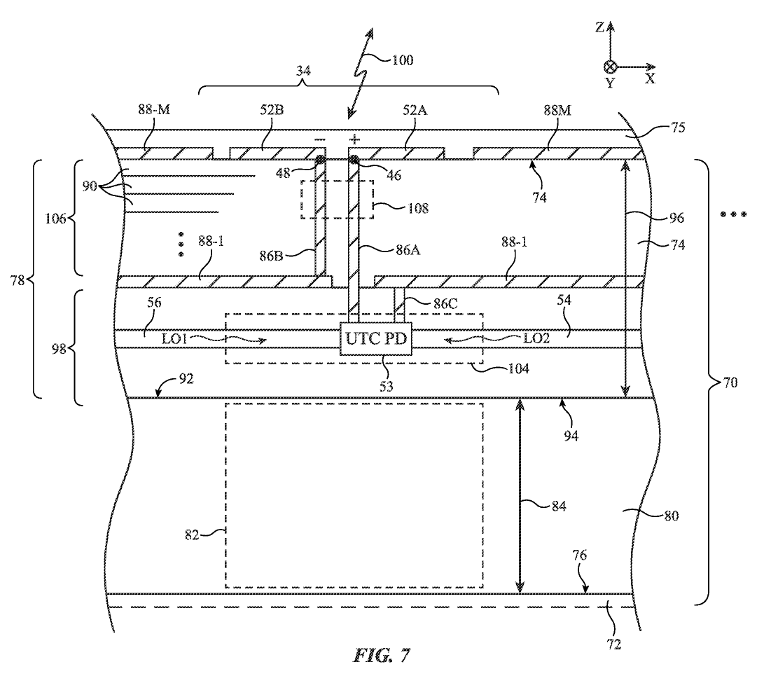

FIG. 7 is a cross-sectional side view showing how a single antenna 34 in phased antenna array 36 may be integrated into a monolithic antenna module such as monolithic antenna module 70. Although only a single antenna 34 is illustrated in FIG. 7 for the sake of clarity, the other antennas 34 in phased antenna array 36 may be similarly integrated into monolithic antenna module 70.

Monolithic antenna module 70 may, for example, be a monolithic microwave integrated circuit (MMIC). Monolithic antenna module 70 is sometimes also referred to herein as integrated circuit (IC) 70, IC chip 70, or chip 70. Monolithic antenna module 70 may include a semiconductor bulk substrate such as bulk 80. Bulk 80 may include silicon (e.g., at the beginning of fabrication bulk 80 may be a pure silicon wafer). Bulk 80 may have a bottom lateral surface 76 and opposing top lateral surface 94. Bulk 80 is sometimes also referred to herein as silicon bulk 80. Bulk 80 may have a thickness 84 (e.g., 200-500 microns).

Monolithic antenna module 70 may also include a backend substrate on surface 94 of bulk 80 such as substrate 78. Substrate 78 may have a bottom lateral surface 92 at surface 94 of bulk 80 and may have an opposing top lateral surface 74. Substrate 78 may, for example, form a backend-of-line (BEOL) for monolithic antenna module 70. Substrate 78 may therefore sometimes also be referred to herein as BEOL 78, chip backend 78, or backend 78.

Substrate 78 may include stacked dielectric (insulator) layers 90. Dielectric layers 90 may include glass, fused quartz, printed circuit board materials, polyimide, ceramic, polymer, aluminum, and/or other materials. Substrate 78 may also include M metallization layers 88 interleaved, stacked, and/or embedded on or between dielectric layers 90. Metallization layers 88 may include an Mth metallization layer 88-M (sometimes referred to herein as top metal 88-M) on the upper-most dielectric layer 90 of substrate 78 (e.g., top surface 74). Metallization layers 88 may also include a metallization layer 88-1. Metallization layer 88-1 may separate electrical portion 106 of substrate 78 from photonic portion 98 of substrate 78. Metallization layer 88-1 may form a bottom or first metallization layer of electrical portion 106 of substrate 78 in some implementations. If desired, metallization layer 88-1 may be held at a ground potential and may form part of the antenna ground 44 of antenna 34 (FIG. 3). Metallization layer 88-1 is sometimes also referred to herein as ground layer 88-1.

The signals conveyed by antenna 34 may be conveyed as electrical signals within electrical portion 106 of substrate 78. The signals conveyed by antenna 34 may be conveyed as optical signals within photonic portion 98 of substrate 78. Photonic portion 98 may include a single dielectric layer 90 or multiple stacked dielectric layers 90. The dielectric layer(s) 90 in photonic portion 98 may be formed from the same material as the dielectric layer(s) 90 in electrical portion 106 or may be formed from a different material than the dielectric layer(s) 90 in electrical portion 106. Photonic portion 98 may be free from metallization layers 88 or may, if desired, include one or more metallization layers. There may be, for example, a bottom-most metallization layer 88 in substrate 78 on lateral surface 92 that separates substrate 78 from bulk 80.

If desired, an optional conductive layer such as reflector 72 may be layered onto lateral surface 76 of bulk 80 opposite substrate 78. Reflector 72 may, for example, reflect some of the radio-frequency signals conveyed by antenna 34 back towards antenna 34, which may improve antenna efficiency, antenna gain, and/or the radiation pattern of the antenna. If desired, bulk 80 may include a cavity 82 that is filled with air or another material. Cavity 82 may overlap antenna 34. Cavity 82 may help to reduce loss in the radio-frequency signals conveyed by antenna 34 relative to implementations where bulk 80 overlaps antenna 34 and/or may help to increase the bandwidth of antenna 34. If desired, the portion of metallization layer 88-1 overlapping the radiator of antenna 34 may be omitted in implementations where bulk 80 includes cavity 82.

Metallization layers 88 (sometimes also referred to herein as conductive traces) may include copper, gold, or other conductive materials. Different metallization layers 88 may be coupled together using conductive vias that extend through one or more dielectric layers 90. If desired, substrate 78 may be grown onto bulk 80 layer-by-layer during the fabrication of monolithic antenna module 70. For example, once bulk 80 has been fabricated and any desired circuitry has been integrated into bulk 80, the layer(s) forming photonic portion 98 may be grown onto surface 94 of bulk 80, then metallization layer 88-1 may be grown onto photonic portion 98, then a first dielectric layer 90 of electrical portion 106 may be grown onto metallization layer 88-1, and so on until metallization layer 88-M. In this way, substrate 78 is monolithically integrated with bulk 80 in monolithic antenna module 70 and is adhered to bulk 80 without any intervening interconnects such as solder or adhesive. Substrate 78 may have a thickness 96 that is less than thickness 84 (e.g., 1-20 microns, 0.5-50 microns, 5-15 microns, 10 microns, etc.).

Antenna 34 may be integrated into substrate 78 during the fabrication of substrate 78 on bulk 80. For example, dipole arms 52A and 52B may be formed from metallization layer 88-M (e.g., the top metal layer of substrate 78) or another metallization layer 88 in substrate 78. Dipole arms 52A and 52B may be layered onto an uppermost dielectric layer 90 in substrate 78 to minimize loss, for example. If desired, an optional passivation layer 75 may be layered over metallization layer 88-M and dipole arms 52A and 52B. The example of FIG. 7 is illustrative and, if desired, dipole arms 52A and 52B may be replaced with any desired radiating elements of antenna 34.

In the example of FIG. 7, UTC PD 53 is embedded within photonic portion 98 of substrate 78 (e.g., at a location overlapping the radiator of antenna 34 when viewed in the -Z direction). Photonic portion 98 of substrate 78 may include the optical path 56 and the optical path 54 used to feed antenna 34. Optical path 56 may, for example, be formed from a first waveguide embedded in photonic portion 98 of substrate 78. Optical path 54 may, for example, be formed from a second waveguide embedded in photonic portion 98 of substrate 78. The waveguides forming optical paths 54 and 56 may be formed from a semiconductor material, silicon nitride, glass, plastic, and/or any other desired optically transparent materials. The optically transparent material used to form optical paths 54 and 56 may have a refractive index that differs from the refractive index of the material used to form the dielectric layer(s) 90 in photonic portion 98 of substrate 78 by at least a threshold amount. This may help to preserve a total internal reflection (TIR) condition of the waveguides to minimize loss of the optical signals conveyed within the waveguides.

UTC PD 53 may have an electrical terminal communicatively coupled to positive antenna feed terminal 46 on dipole arm 52A over a conductive via 86A extending through substrate 78. Antenna 34 may include an additional conductive via 86B that couples ground antenna feed terminal 48 on dipole arm 52B to metallization layer 88-1. If desired, UTC PD 53 may have an additional electrical terminal coupled to metallization layer 88-1 over conductive via 86C. Alternatively, the additional electrical terminal may be coupled to ground antenna feed terminal 48 on dipole arm 52B over conductive via 86B, conductive via 86C, and/or one or more conductive traces in metallization layer 88-1 that couples conductive via 86B to conductive via 86C. This example is illustrative and, if desired, other feeding arrangements may be used to feed the radiator for antenna 34.

Antenna 34 may include optical components such as optics 104 in photonic portion 98 of substrate 78. Optics 104 may, for example, be disposed at locations in photonic portion 98 that overlap the radiator of antenna 34 (e.g., dipole arms 52A and 52B may overlap optics 104). Optics 104 may be optically coupled to optical path 56, optical path 54, and/or the optically sensitive region of UTC PD 53. Optics 104 may include, for example, one or more optical combiners, electro-optical components, portions of optical paths 54 and 56 and/or other optical paths, the optical phase shifter 60 (FIG. 5) for antenna 34, and/or the EOM 58 (FIG. 5) for antenna 34. In implementations where UTC PD 53 is disposed in photonic portion 98 of substrate 78, UTC PD 53 may form part of optics 104.

This example is illustrative and non-limiting. If desired, antenna 34 may include two pairs of dipole arms 52 for covering orthogonal polarizations (FIG. 6). In general, antenna 34 may include any desired type of antenna resonating element formed from any desired metallization layer(s) on substrate 78. If desired, UTC PD 53 may be disposed on or in electrical portion 106 of substrate 78 instead of in photonic portion 98. For example, UTC PD 53 may be embedded within electrical portion 106 below dipole arms 52A and 52B, such as at location 108. If desired, the UTC PD may be embedded within electrical portion 106 at the boundary with photonic portion 98, in which case some of the UTC PD may also extend into the photonic portion. If desired, the UTC PD may be embedded within photonic portion 98 at the boundary with electrical portion 106, in which case some of the UTC PD may also extend into the electrical portion.

In these implementations, UTC PD 53 may be coupled to ground antenna feed terminal 48 over conductive via 86B and may be coupled to positive antenna feed terminal 46 over conductive via 86A (conductive via 86C may be omitted). Substrate 78 may include an additional vertical optical path (not shown) that optically couples optical paths 56 and 54 to UTC PD 53 at location 108. If desired, optics 104 may include one or more optical couplers that redirect optical local oscillator signal LO1 upwards from optical path 56 to UTC PD 53 via the vertical optical path and that redirect optical local oscillator signal LO2 upwards from optical path 54 to UTC PD 53 via the vertical optical path. The optical coupler(s) may include mirrors, partial reflectors, coupling prisms, angled waveguide edges or faces, diffractive gratings (e.g., holograms, surface relief gratings, metagratings, etc.), and/or any other desired optical couplers.

UTC PD 53 may convey electrical signals (antenna current) on dipole arms 52A and 52B over conductive vias 86B and 86C based on optical local oscillator signals LO1 and LO2. Antenna 34 may convey radio-frequency signals 100 associated with the electrical signals (e.g., at relatively high frequencies such as millimeter wave, sub-THz, or THz frequencies).

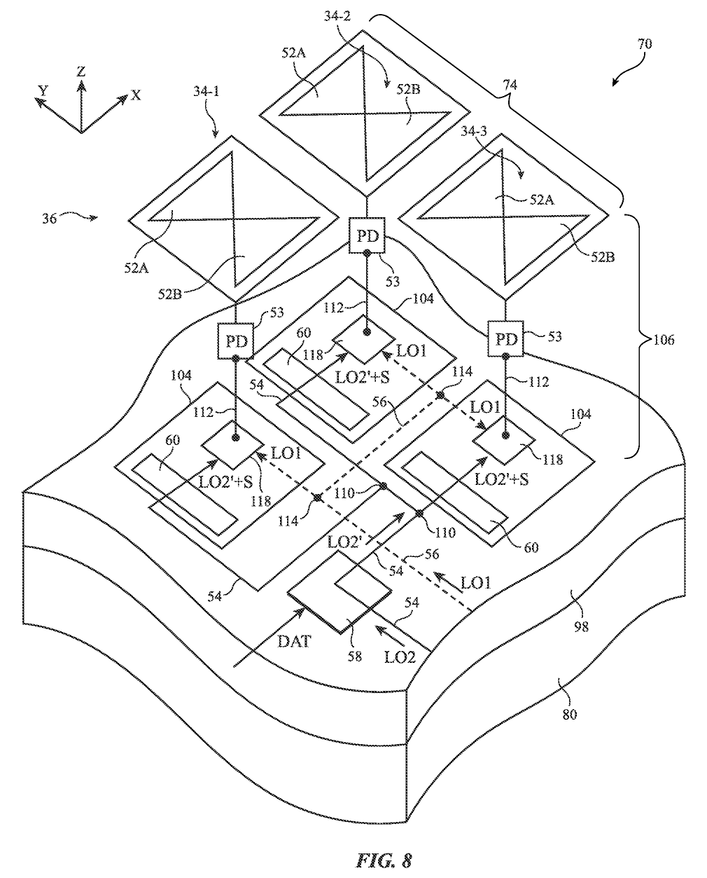

If desired, the same EOM 58 (FIG. 5) may be shared between multiple antennas 34 in monolithic antenna module 70. FIG. 8 is a perspective view showing how at least three antennas 34-1, 34-2, and 34-3 in a phased antenna array 36 on monolithic antenna module 70 may share the same EOM 58. In the example of FIG. 8, the dielectric layers 90 in electrical portion 106 of substrate 78 have been omitted for the sake of clarity.

In the example of FIG. 8, the UTC PDs 53 of antennas 34-1, 34-2, and 34-3 are disposed in electrical portion 106 of substrate 78 (e.g., at location 108 of FIG. 7) rather than in photonic portion 98 of substrate 78. The example of FIG. 8 illustrates antennas 34-1, 34-2, and 34-3 as single polarization antennas each having respective dipole arms 52A and 52B for the sake of clarity. If desired, antennas 34-1, 34-2, and 34-3 may include dual-polarization antennas (see, e.g., FIG. 6) and the components for each antenna in electrical portion 106 and photonic portion 98 may be duplicated for covering the orthogonal polarization.

As shown in FIG. 8, antennas 34-1, 34-2, and 34-3 may each include a respective radiator in or on lateral surface 74. Antennas 34-1, 34-2, and 34-3 may each include respective optics 104 in photonic portion 98 of substrate 78. The optics 104 in each of antennas 34-1, 34-2, and 34-3 may overlap the corresponding radiator of that antenna. Antennas 34-1, 34-2, and 34-3 may each include a respective UTC PD 53 coupled between the optics 104 and the radiator of the corresponding antenna (e.g., where the UTC PD 53 in each antenna is vertically interposed between the optics 104 and the radiator of that antenna). Antennas 34-1, 34-2, and 34-3 may each include a respective optical path 112 (e.g., a vertical optical path) that couples the optics 104 of that antenna to the UTC PD 53 of that antenna. The radiator, UTC PD 53, optical path 112, and optics 104 of a given antenna 34 are sometimes also referred to herein collectively as an antenna unit cell (e.g., where FIG. 8 illustrates three antenna unit cells).

In the example of FIG. 8, monolithic antenna module 70 modulates optical local oscillator signal LO2 and applies phase shifts S (FIG. 5) to optical local oscillator signal LO2 rather than to optical local oscillator signal LO1. This is illustrative and non-limiting and, if desired, monolithic antenna module 70 may alternatively apply phase shifts S to optical local oscillator signal LO1 (e.g., as shown in the example of FIG. 5).

As shown in FIG. 8, photonic portion 98 of substrate 78 may include optical path 54 (e.g., one or more optical waveguides). EOM 58 may be disposed on optical path 54 in photonic portion 98 of substrate 78. EOM 58 may receive optical local oscillator signal LO2 over optical path 54 (e.g., from light source(s) 66 of FIG. 5). EOM 58 may receive wireless data DAT as an electrical signal (e.g., from DAC 62 of FIG. 5). EOM 58 may modulate wireless data DAT onto optical local oscillator signal LO2 to produce modulated optical local oscillator signal LO2’. EOM 58 may be an in-phase quadrature-phase (I/Q) electro-optical modulator if desired.

EOM 58 may distribute modulated optical local oscillator signal LO2’ to the optical phase shifter 60 in the optics 104 for each of antennas 34-1, 34-2, and 34-3 over optical path 54. If desired, optical path 54 may include one or more optical splitters 110 (e.g., optical couplers, partial reflectors, etc.) that help to fan out optical path 54 to the optics 104 on each of antennas 34-1, 34-2, and 34-3. In this way, antennas 34-1, 34-2, and 34-3 may share the same EOM 58 and may convey the same wireless data DAT. This may be generalized to any desired number of antennas 34 in phased antenna array 36 sharing the same EOM 58. While referred to herein as optical splitters, optical splitters 110 may equivalently form optical combiners in the reverse direction.

Each optical phase shifter 60 may impart a respective optical phase shift S to the modulated optical local oscillator signal LO2’ received from EOM 58 to produce a corresponding phase shifted modulated optical local oscillator signal LO2’ + S. Different phase shifts S may be applied across the antennas 34 of monolithic antenna module 70 to perform suitable beamforming. If desired, each optical phase shifter 60 may be formed from treated (doped) semiconductor material that responds to an electric DC voltage (not shown) by changing its refractive index and thus path length to impart a desired phase shift to the optical local oscillator signal.

The optics 104 in antennas 34-1, 34-2, and 34-3 may each include a respective optical combiner 118. Optical combiners 118 (sometimes also referred to herein as optical adders 118) may include optical couplers (e.g., adjacent optical paths that couple optical signals between the paths) and/or any other desired optical combining components. While referred to herein as optical combiners, optical combiners 118 may equivalently form optical splitters in the reverse direction. Optical combiners 118 are sometimes also referred to herein more generally as optical couplers 118.

Photonic portion 98 of substrate 78 may also include optical path 56 (e.g., one or more optical waveguides). Optical path 56 bypasses EOM 58 and is optically coupled to the optical combiner 118 in the optics 104 of each of antennas 34-1, 34-2, and 34-3. If desired, optical path 56 may include one or more optical splitters 114 that help to fan out optical path 56 to the optics 104 on each of antennas 34-1, 34-2, and 34-3. Optical path 56 may distribute optical local oscillator signal LO1 (e.g., from light source(s) 66 in FIG. 5) to the optical combiner 118 for each antenna 34 in phased antenna array 36. In this way, antennas 34-1, 34-2, and 34-3 may share the same optical local oscillator signal LO1. This may be generalized to any desired number of antennas 34 in phased antenna array 36. While referred to herein as optical splitters, optical splitters 114 may equivalently form optical combiners in the reverse direction.

In the optics 104 of each of antennas 34-1, 34-2, and 34-3, optical combiner 104 may combine the phase shifted modulated optical local oscillator signal LO2’ + S received over optical path 54 with the optical local oscillator signal LO1 received over optical path 56 to produce a combined optical signal on optical path 112. Optical path 112 may illuminate the photoactive region of the corresponding UTC PD with the combined optical signal, causing the UTC PD to produce corresponding antenna current on its radiator. The example of FIG. 8 illustrates signal transmission for the sake of clarity. The components shown in FIG. 8 may also be used to perform signal reception (e.g., each UTC PD may produce an electrical signal such as an intermediate frequency signal on additional electrical paths (not shown) responsive to wireless signals incident upon phased antenna array 36, each UTC PD may produce optical signals on optical paths 112 or other optical paths (not shown) responsive to wireless signals incident upon phased antenna array 36, etc.).

EOM 58 may be offset from and non-overlapping with respect to the antennas 34 in phased antenna array 36 (e.g., EOM 58 may be offset from and/or disposed outside of optics 104). EOM 58 may, for example, be disposed on a first region of monolithic antenna module 70 (e.g., a peripheral region of the antenna module) whereas antennas 34 are disposed on a second region of monolithic antenna module 70 (e.g., a central region of the antenna module). When implemented in this way, each antenna 34 may exhibit a compact lateral footprint helping to accommodate optical signal routing in the module. In addition, the optical local oscillator signals may be efficiently routed to each of the antennas 34 in phased antenna array 36 within photonic portion 98 of substrate 78 (e.g., with substantially less loss than when electrical signals are distributed to each of the antennas in the array).

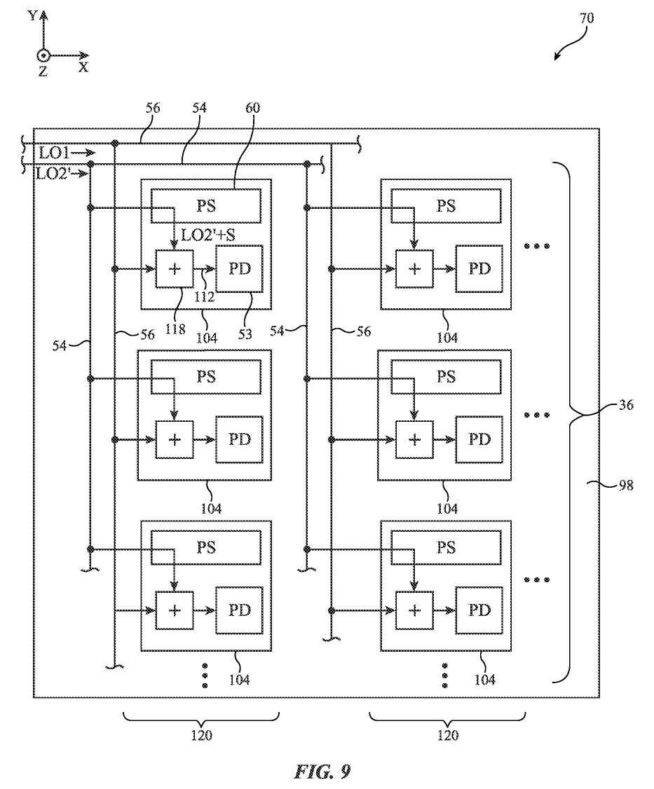

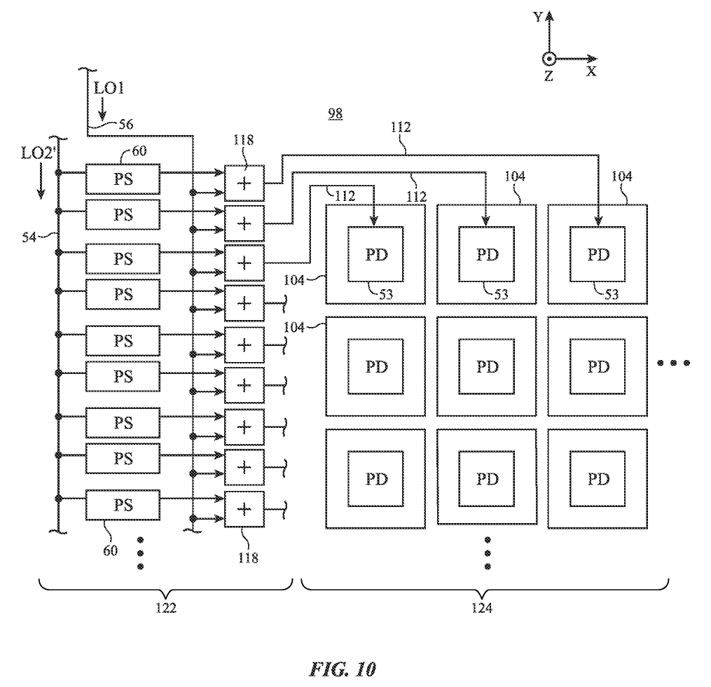

The example of FIG. 8 in which UTC PDs 53 are disposed in electrical portion 106 of substrate 78 (e.g., at location 108 of FIG. 7) is illustrative and non-limiting. FIG. 9 is a top view showing one example of how the UTC PD 53 for each antenna 34 of phased antenna array 36 may be included in the optics 104 of that antenna 34 in photonic portion 98 of substrate 78. The example of FIG. 9 illustrates a phased antenna array 36 that includes at least six antennas 34. The optics 104 in photonic portion 98 of substrate 78 for each of the six antennas 34 in phased antenna array 36 are illustrated in FIG. 9. In general, phased antenna array 36 may include any desired number of antennas.

As shown in FIG. 9, the optics 104 for each antenna 34 in phased antenna array 36 may include a corresponding optical phase shifter 60, optical combiner 118, UTC PD 53, and optical path 112 (e.g., a waveguide embedded in photonic portion 98 of substrate 78). Each optical phase shifter 60 may be disposed on optical path 56. Each optical phase shifter 60 receives modulated optical local oscillator signal LO2’ over optical path 56 and produces a corresponding phase shifted modulated optical local oscillator signal LO2’ + S that is provided to the corresponding optical combiner 118. Each optical combiner 118 also receives optical local oscillator signal LO1 over optical path 54. Each optical combiner 118 combines optical local oscillator signal LO1 with its phase shifted modulated optical local oscillator signal LO2’ + S to generate a combined optical signal on its optical path 112 that illuminates the corresponding UTC PD 53.

In the example of FIG. 9, the antennas 34 in phased antenna array 36 are arranged in a pattern of repeating columns 120. If desired, optical paths 56 and 54 may each include respective branches that provide the optical local oscillator signals to the antennas 34 in each column 120. This may help to minimize optical signal routing complexity and loss, for example. The example of FIG. 9 in which optical phase shifters 60 and optical combiners 118 are included in the optics 104 for each antenna 34 in phased antenna array 36 (e.g., at locations overlapping the radiators in the antennas of the array) is illustrative and non-limiting. Alternatively, optical phase shifters 60 and/or optical combiners 118 may be disposed in a different region of photonic portion 98 of substrate 78 than the optics 104 of antennas 34.

FIG. 10 is a top view showing one example of how optical phase shifters 60 and optical combiners 118 may be disposed in a different region of photonic portion 98 of substrate 78 than the optics 104 of antennas 34. As shown in FIG. 10, optics 104 may be disposed in a first region 124 of the lateral area spanned by photonic portion 98 of substrate 78. Optics 104 may include UTC PDs 53 or, if desired, UTC PDs 53 may overlap optics 104 (e.g., as shown in FIG. 8). The optics 104 in region 124 may overlap the radiators of the antennas 34 in phased antenna array 36.

On the other hand, optical phase shifters 60 and optical combiners 118 may be offloaded to a second region 122 of the lateral area spanned by photonic portion 98 of substrate 78. Region 122 may be smaller than region 124 if desired. As one example, region 124 may form a central region of the monolithic antenna module whereas region 122 forms a peripheral region of the monolithic antenna module (e.g., extending around some or all of a periphery of the central region). Each optical phase shifter 60 may receive modulated optical local oscillator signal LO2’ over optical path 54. Each optical phase shifter 60 may apply a respective optical phase shift S to modulated optical local oscillator signal LO2’ and may provide its phase shifted modulated optical local oscillator signal to a different respective optical combiner 118.

Each optical combiner 118 may also receive optical local oscillator signal LO1 over optical path 56 and may generate a respective combined optical signal by combining the received optical local oscillator signal LO1 with the phase shifted and modulated optical local oscillator signal received from its respective optical phase shifter 60. Each optical combiner 118 may output the combined signal onto a respective optical path 112. Each optical path 112 may propagate a respective combined signal to a respective UTC PD 53 in region 124. Offsetting optical phase shifters 60 and signal combiners 118 from optics 104 in this way may help to minimize the optical routing complexity in providing optical signals to UTC PDs 53 (e.g., by eliminating the need to route signal path 56 to each unit cell in region 124.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An integrated circuit comprising:
a silicon bulk;
a dielectric substrate on the silicon bulk;
a photodiode;
a first optical path embedded in the dielectric substrate and configured to illuminate the photodiode using a first optical signal;
a second optical path embedded in the dielectric substrate and configured to illuminate the photodiode using a second optical signal; and
an antenna having a radiator on a surface of the dielectric substrate opposite the silicon bulk, the photodiode having an electrical terminal communicatively coupled to the radiator.

2. The integrated circuit of claim 1, wherein the first optical signal is at a first frequency, the second optical signal is at a second frequency different than the first frequency, and the radiator is configured to radiate a wireless signal at a third frequency associated with a difference between the first and second frequencies.

3. The integrated circuit of claim 1, wherein the dielectric substrate comprises:
a stack of electrical layers;
one or more photonic layers interposed between the stack of electrical layers and the silicon bulk; and
a metallization layer that separates the stack of electrical layers from the one or more photonic layers, the first and second waveguides being embedded in the one or more photonic layers.

4. The integrated circuit of claim 3, wherein the photodiode is embedded at least in the one or more photonic layers and the integrated circuit further comprises one or more conductive vias coupling the electrical terminal of the photodiode to an antenna feed terminal on the radiator through at least some of the one or more photonic layers and through the stack of electrical layers.

5. The integrated circuit of claim 3, wherein the photodiode is embedded at least in the stack of electrical layers and the integrated circuit further comprises:
a conductive via that couples the electrical terminal of the photodiode to an antenna feed terminal on the radiator through at least some of the stack of electrical layers; and
one or more vertical optical paths that optically couple the first and second optical paths to the photodiode through at least some of the one or more photonic layers and through at least some of the stack of electrical layers.

6. The integrated circuit of claim 1, wherein the photodiode overlaps the radiator and the integrated circuit further comprises:
an optical coupler overlapping the radiator and embedded in the dielectric substrate; and
a third optical path optically coupled to the photodiode, wherein the optical coupler optically couples the first and second optical paths to the third optical path.

7. The integrated circuit of claim 6, wherein the photodiode is vertically interposed between the optical coupler and the radiator and wherein the third optical path extends vertically through at least some of the dielectric substrate.

8. The integrated circuit of claim 6, further comprising:
an optical phase shifter disposed on the first optical path, wherein
the optical phase shifter is embedded in the dielectric substrate,
the optical phase shifter overlaps the radiator,
the optical phase shifter is configured to impart an optical phase shift to the first optical signal, and
the optical coupler is optically coupled between the third optical path and the optical phase shifter.

9. The integrated circuit of claim 8, wherein the optical phase shifter, the optical coupler, and the photodiode are disposed on a same layer of the dielectric substrate.

10. The integrated circuit of claim 8, further comprising:
an electro-optical modulator (EOM) disposed on the first optical path, wherein
the EOM is embedded in the dielectric substrate,
the optical phase shifter is optically coupled between the EOM and the optical coupler,
the EOM is non-overlapping with respect to the radiator, and
the EOM is configured to modulate wireless data onto the first optical signal.

11. The integrated circuit of claim 1, wherein the photodiode overlaps the radiator and the integrated circuit further comprises:
an optical phase shifter disposed on the first optical path and embedded in the dielectric substrate; and
an optical coupler that is embedded in the dielectric substrate and that optically couples the first and second optical paths to the photodiode over a third optical path, wherein
the optical coupler is optically coupled between the optical phase shifter and the third optical path, and
the optical phase shifter and the optical coupler are non-overlapping with respect to the radiator and the photodiode.

12. The integrated circuit of claim 1, wherein the photodiode comprises a uni-travelling-carrier photodiode, the first optical path comprises a first waveguide, and the second optical path comprises a second waveguide.

13. The integrated circuit of claim 12, wherein the first and second waveguides comprise a semiconductor material embedded in the dielectric substrate.

14. An antenna module comprising:
a silicon bulk;
a dielectric substrate layered onto the silicon bulk;
a phased antenna array including
radiators formed from conductive traces on a surface of the dielectric substrate opposite the silicon bulk, and
photodiodes electrically coupled to the radiators;
a first optical path embedded in the dielectric substrate and configured to convey a first optical signal that illuminates the photodiodes in the phased antenna array; and
a second optical path embedded in the dielectric substrate and configured to convey a second optical signal that illuminates the photodiodes in the phased antenna array.

15. The antenna module of claim 14, further comprising:
optical phase shifters disposed on the first optical path, embedded in the dielectric substrate, and configured to apply optical phase shifts to the first optical signal; and
optical couplers embedded in the dielectric substrate and configured to optically couple the first and second optical paths to the photodiodes in the phased antenna array.

16. The antenna module of claim 15, further comprising:
an electro-optical modulator (EOM) disposed on the first optical path, embedded in the substrate, and configured to modulate wireless data onto the first optical signal.

17. The antenna module of claim 16, wherein the EOM is non-overlapping with respect to the radiators in the phased antenna array.

18. The antenna module of claim 17, wherein the optical phase shifters and the optical couplers overlap the radiators in the phased antenna array.

19. The antenna module of claim 17, wherein the optical phase shifters and the optical couplers are non-overlapping with respect to the radiators in the phased antenna array.

20. An electronic device comprising:
a silicon bulk;
a dielectric substrate grown onto the silicon bulk;
a first antenna radiator on a surface of the dielectric substrate opposite the silicon bulk;
a second antenna radiator on the surface of the dielectric substrate;
a first photodiode communicatively coupled to the first antenna radiator;
a second photodiode communicatively coupled to the second antenna radiator;
first and second optical combiners embedded in the dielectric substrate;
first and second optical phase shifters embedded in the dielectric substrate;
a first optical path that couples the first optical combiner to the first photodiode;
a second optical path that couples the second optical combiner to the second photodiode;
a first waveguide embedded in the dielectric substrate, coupled to the first and second optical combiners, and configured to convey a first optical local oscillator (LO) signal to the first and second optical combiners;
a second waveguide embedded in the dielectric substrate, coupled to the first and second optical combiners, and configured to convey a second optical LO signal to the first and second optical combiners; and
an electro-optical modulator embedded in the dielectric substrate, disposed on the first waveguide, and configured to modulate wireless data onto the first optical LO signal.
